(19) United States
(12) Patent Application Publication
(10) Pub. No.: US 2025/0159684 A1
(43) Pub. Date: May 15, 2025

(54) MAPPING RELATIONSHIP DETERMINING METHOD AND APPARATUS AND STORAGE MEDIUM

(71) Applicant: Beijing Xiaomi Mobile Software Co., Ltd., Beijing (CN)

(72) Inventor: Qun ZHAO, Beijing (CN)

(21) Appl. No.: 18/840,020

(22) PCT Filed: Feb. 25, 2022
(86) PCT No.: PCT/CN2022/077908

§ 371 Date: Aug. 20, 2024

(51) Int. Cl. H04W 72/1273; H04W 56/00

(52) U.S. Cl. CPC H04W 72/1273; H04W 56/0015

(57) ABSTRACT

A mapping relationship determining method includes: determining that a scheduling window is associate with a plurality of group-radio network temporary identities (GRNTIs); and determining, based on a pre-determined priority sequence, a mapping relationship between a monitoring occasion (MO) of each search space in the scheduling window and a synchronization signal and PBCH block (SSB), where the MO is used for monitoring a time-domain position of a physical downlink control channel (PDCCH).

### CROSS-REFERENCE TO RELATED APPLICATION

The present application is a U.S. National Stage of International Application No. PCT/CN2022/077908, filed on Feb. 25, 2022, the contents of all of which are incorporated herein by reference in their entireties for all purposes.

### BACKGROUND OF THE INVENTION

A Release-17 (Rel-17) multicast broadcast service (MBS) supports an IDLE/INACTIVE terminal to receive an MBS service. Considering that the IDLE/INACTIVE terminal does not feedback beam information to a network side device, data needs to be sent in different beam directions so as to ensure that terminals at different physical positions in a cell can receive the MBS service.

### SUMMARY OF THE INVENTION

Examples of the disclosure provide a mapping relationship determining method and apparatus and a storage medium.

According to a first aspect of the examples of the disclosure, a mapping relationship determining method is provided, including:
determining that a scheduling window is associate with a plurality of group-radio network temporary identities (G-RNTIs); and
determining, based on a pre-determined priority sequence, a mapping relationship between a monitoring occasion (MO) of each search space in the scheduling window and a synchronization signal and PBCH block (SSB); where the MO is used for monitoring a time-domain position of a physical downlink control channel (PDCCH).

According to a second aspect of the examples of the disclosure, a computer readable storage medium is provided. The storage medium stores a computer program, and the computer program is used for executing the mapping relationship determining method according to any one of the above.

According to a third aspect of the examples of the disclosure, a mapping relationship determining apparatus is provided, including:
a processor; and
a memory configured to store processor executable instructions;
where the processor is configured to execute the mapping relationship determining method according to any one of the above.

It is to be understood that above general descriptions and later detailed descriptions are merely examples and illustrative, and cannot limit the disclosure.

### BRIEF DESCRIPTION OF DRAWINGS

Accompanying drawings here are incorporated into the specification, constitute a part of the specification, show examples consistent with the disclosure, and are used for explaining a principle of the disclosure together with the specification.

FIG. 1 is a schematic diagram of a scenario in which a scheduling window is associate with a plurality of G-RNTIs illustrated according to an example.

FIG. 2 is a schematic flowchart of a mapping relationship determining method illustrated according to an example.

FIG. 3 is a schematic flowchart of another mapping relationship determining method illustrated according to an example.

FIG. 4 is a schematic flowchart of another mapping relationship determining method illustrated according to an example.

FIG. 5 is a schematic diagram of a mapping relationship determining scenario illustrated according to an example.

FIG. 6 is a schematic diagram of another mapping relationship determining scenario illustrated according to an example.

FIG. 7 is a schematic diagram of another mapping relationship determining scenario illustrated according to an example.

FIG. 8 is a block diagram of a mapping relationship determining apparatus illustrated according to an example.

FIG. 9 is a schematic structural diagram of a mapping relationship determining apparatus illustrated by the disclosure according to an example.

FIG. 10 is a schematic structural diagram of another mapping relationship determining apparatus illustrated by the disclosure according to an example.

### DETAILED DESCRIPTION OF THE INVENTION

Examples will be illustrated in detail here, and their instances are shown in accompanying drawings. When the following description refers to the accompanying drawings, unless otherwise indicated, the same numbers in different accompanying drawings indicate the same or similar elements. Embodiments described in the following examples do not represent all embodiments consistent with the disclosure. Rather, they are merely instances of apparatuses and methods consistent with some aspects of the disclosure as detailed in the appended claims.

Terms used in the disclosure are merely for the purpose of describing specific examples, and not intended to limit the disclosure. “One”, “said” and “the” of singular forms used in the disclosure and the appended claims are also intended to include plural forms unless the context clearly indicates other meanings. It is also to be understood that a term “and/or” as used here refers to and includes any or all possible combinations of at least one associated listed item.

It is to be understood that although terms first, second, third, etc. may be used for describing various pieces of information in the disclosure, such information is not to be limited to these terms. These terms are merely used for distinguishing the same type of information from each other. For example, without departing from the scope of the disclosure, first information may also be referred to as second information, and similarly, the second information may also be referred to as the first information. Depending on the context, for example, a word “if” as used here may be interpreted as “at the time” or “when” or “in response to determining”.

When a plurality of group-radio network temporary identities (G-RNTIs) are associate with a multicast traffic channel (MTCH) scheduling window, there is no clear solution currently on how to determine a correspondence between a monitoring occasion (MO) of a PDCCH and a synchronization signal and PBCH block (SSB).

Currently, a basic idea in a standard about a mapping relationship between each MO in a scheduling window and SSBs is that each PDCCH monitoring in the scheduling window is mapped one by one with N SSBs in a time sequence.

When the MTCH scheduling window is associate with merely one G-RNTI, according to a one-to-one mapping mode of the MOs and the SSBs, it may be ensured that each MO of a search space (SS) can traverse all the SSBs.

However, when the MTCH scheduling window is associate with a plurality of G-RNTIs, it results in the MO of a search space with a large period not being able to traverse all the SSBs, thus leading to part of terminals not being able to receive a PDCCH transmitted in the search space.

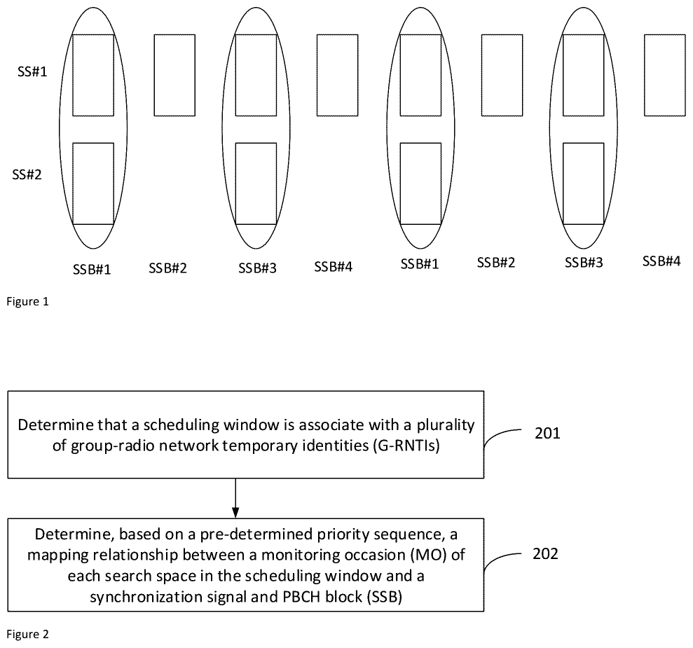

Referring to FIG. 1, it is assumed that the scheduling window is associate with G-RNTI #1 and G-RNTI #2, where a transmission period of a search space SS #1 is 1 slot, a transmission period of SS #2 is 2 slots, a PDCCH transmitted in SS #1 is scrambled through G-RNTI #1, and a PDCCH transmitted in SS #2 is scrambled through G-RNTI #2.

The MO of the search space SS #2 with a large period is not able to traverse all the SSBs, thus leading to part of the terminals is not able to receive the PDCCH transmitted in the search space.

To solve this technical problem, the disclosure related to the field of communications provides a mapping relationship determining method and apparatus and a storage medium.

The mapping relationship determining method provided by the disclosure is first introduced below from the side of a network side device.

An example of the disclosure provides a mapping relationship determining method. Referring to FIG. 2, FIG. 2 is a flowchart of a mapping relationship determining method illustrated according to an example, which may be performed by a network side device, where the network side device may be a base station, and the method may include the following steps.

In step 201, a scheduling window associating with a plurality of group-radio network temporary identities (G-RNTIs) is determined.

In the example of the disclosure, the scheduling window may be an MTCH scheduling window.

In a possible embodiment, PDCCHs transmitted in the different search spaces of the scheduling window are scrambled through different G-RNTIs in the plurality of G-RNTIs associate with the scheduling window.

For example, the plurality of G-RNTIs associate with the scheduling window include G-RNTI #1 and G-RNTI #2, the search spaces include SS #1 and SS #2, the PDCCH transmitted in SS #1 may be scrambled through G-RNTI #1, and the PDCCH transmitted in SS #2 may be scrambled through G-RNTI #2.

In step 202, based on a pre-determined priority sequence, a mapping relationship between a monitoring occasion (MO) of each search space in the scheduling window and a synchronization signal and PBCH block (SSB) is determined.

In the example of the disclosure, the MO is used for monitoring a time-domain position of the physical downlink control channel (PDCCH).

In a possible embodiment, the priority sequence may be pre-agreed by a protocol or configured by a base station, which is not limited by the disclosure.

In another possible embodiment, the priority sequence may be a sequence of transmission period durations of the search spaces from large to small.

In another possible embodiment, in a case where the transmission period durations of the plurality of search spaces are equal, the priority sequence may be a sequence of identities of the search spaces from small to large, or the priority sequence may be a sequence of the identities of the search spaces from large to small, which is not limited by the disclosure.

For example, the transmission period durations of SS #1 and SS #2 in the scheduling window are equal, and based on the priority sequence, the network side device may first determine the mapping relationship between the MO of SS #1 and the SSB, and then determine the mapping relationship between the MO of SS #2 and the SSB. Or, the network side device may first determine the mapping relationship between the MO of SS #2 and the SSB, and then determine the mapping relationship between the MO of SS #1 and the SSB.

The above is merely an example illustration, and the priority sequence in a practical application may also be an arrangement sequence of other information related to the search spaces, which is not limited by the disclosure.

In the above example, when one scheduling window is associate with the plurality of G-RNTIs, the network side device can accurately determine the mapping relationship between the MO of each search space and the SSB, so as to ensure that terminals at different geographic positions in a cell can receive the PDCCH transmitted in the search space, such that the normal operation of a terminal service is ensured, and the availability is high.

In some optional examples, the network side device may, in a case where the scheduling window is associate with the plurality of G-RNTIs, determine the mapping relationship between the MO of each search space in the scheduling window and the SSB in the following mode.

In step one, in the scheduling window, a mapping relationship between MOs of a first search space and SSBs is first determined.

In the example of the disclosure, the first search space is a search space with a highest priority determined based on the pre-determined priority sequence, and in a possible embodiment, the first search space is an SS (Search Space) with a largest transmission period duration.

In the example of the disclosure, the network side device may determine, based on a first mapping mode, the mapping relationship between the MOs of the first search space and the SSBs.

Specifically, the first mapping mode may include:

the MOs of the first search space in a time sequence from early to late being in one-to-one correspondence with the SSBs with identities from small to large in each mapping loop of the scheduling window.

In the example of the disclosure, the number of the mapping loops may be determined based on the number of the MOs of the first search space in the scheduling window and the number of the SSBs transmitted in the scheduling window. The number of the SSBs here may be the number of SSBs actually sent in the scheduling window as informed to a terminal by the network side device via system information.

In a possible embodiment, the number X of the mapping loops may be obtained by calculating a quotient of the number of the MOs of the first SS and the number N of the SSBs.

The first mapping mode is specifically:
the [x×N+K]^{th} MO in the scheduling window corresponding to the K^{th} SSB, i.e., the [x×N+K]^{th} MO being associate with the K^{th} SSB,
where x=0,1, . . . X−1, K=1, 2, . . . N, and X=the number of the MOs of the first SS in the scheduling window/N.

In step two, in the scheduling window, a mapping relationship between MOs of a second search space and the SSBs is determined.

In the example of the disclosure, the second search space may be an SS with a transmission period duration that is merely smaller than the transmission period duration of the first search space, or the second search space may be an SS with a transmission period duration equal to that of the first search space but with a larger SS ID.

Further, a second mapping mode corresponding to the second SS needs to be determined based on an overlapping relationship between the MOs of the second SS and MOs of a designated SS in time domain, and thus the mapping relationship between the MOs of the second SS and the SSBs is determined.

In the example of the disclosure, the designated SS is a search space where a mapping relationship between the MOs and the SSBs has been determined, at which moment the designated SS is the first SS above-mentioned.

It needs to be noted that the overlapping relationship of the disclosure refers to the number of symbols of overlapping among the MOs of the search spaces in time domain.

In a first case, where the overlapping relationship indicates that the MOs of the second search space do not overlap at all in time domain with any MO of the designated search space, i.e., the first search space above-mentioned, it may be determined that the second mapping mode corresponding to the second search space is the same as a mapping mode of the designated search space.

Specifically, the overlapping relationship indicates that the number of symbols of the MOs of the second search space overlapping with the MOs of the designated search space in time domain is zero. The second SS may determine a mapping relationship between the MOs of the second SS and the SSBs based on the first mapping mode in step one.

In a second case, where the overlapping relationship indicates that the MOs of the second search space overlap completely in time domain with the MOs of the designated search space, i.e., the first search space above-mentioned, it may be also determined that the second mapping mode corresponding to the second SS is the same as the mapping mode of the designated search space.

Specifically, the overlapping relationship indicates that the number of symbols of the MOs of the second search space overlapping with the MOs of the designated search space in time domain is S, and S is the total number of symbols included in all MOs of the second search space. The second SS may also determine a mapping relationship between the MOs of the second SS and the SSBs based on the first mapping mode in step one.

Considering that the MOs of the second SS overlap completely with the MOs of the first SS and the mapping relationship between the MOs of the first SS and the SSBs has already been determined, there is no need to repeat the determination of the mapping relationship between the MOs of the second SS and the SSBs at this time, and it is possible to determine the mapping relationship between the MOs of the first SS and the SSBs directly as the mapping relationship between the MOs of the second SS and the SSBs.

In a third case, where the overlapping relationship indicates that part of the MOs of the second search space overlaps in time domain with part of the MOs of the designated search space, the second mapping mode may include:
each MO on the second search space which has the overlapping relationship with the designated search space corresponding to a designated SSB; and
the other MOs of the second search space in a time sequence from early to late being in one-to-one correspondence with the remaining SSBs.

The designated SSB is an SSB corresponding to the MO on the designated search space having the overlapping relationship with the second search space.

Specifically, the overlapping relationship indicates that the number of symbols of the MOs of the second search space overlapping with the MOs of the designated search space in time domain is S′, and S′ is smaller than the total number S of symbols included in all MOs of the second search space. If part of MOs of the second search space overlaps with part of MOs of the designated search space at a symbol level in time domain, part of MOs of the second search space overlaps with part of MOs of the designated search space in time domain is determined.

Assuming that the MOs on the second search space that have this overlapping relationship with the designated search space are MO #1 and MO #3, the designated SSBs are the SSBs corresponding to the MOs on the designated search space that have the overlapping relationship with the second search space (assumed to be MO #1 and MO #2 of the designated search space), assumed to be SSB #1 and SSB #2 respectively, and it is directly determined that the SSB corresponding to MO #1 of the second search space is SSB #1 and the SSB corresponding to MO #3 of the second search space is SSB #2.

In addition, the network side device may map one by one other MOs of the second search space, i.e., MOs of the second search space that do not overlap with the MOs of the designated search space at any symbol level in time domain, to the remaining SSBs in a time sequence from early to late.

For example, the other MOs of the second search space include MO #2 and MO #4, the remaining SSBs include SSB #3 and SSB #4, then MO #2 of the second search space corresponds to SSB #3, and MO #4 of the second search space corresponds to SSB #4.

At this time, the second mapping mode is similar to the first mapping mode and may be specifically:
the [y×M+K]^{th} MO in the scheduling window being associate with the P^{th} SSB.

The [y×M+K]^{th} MO is any MO of the second SS that does not overlap with the MOs of the first SS, y=0, 1, . . . Y−1, P=1, 2, . . . M, M=N-number of first SSBs that have been mapped, and Y=number of MOs on the second SS in the scheduling window that have not been mapped with the SSBs/M.

In step three, the above steps one to two are repeated until the mapping relationship between the MOs of each search space in the scheduling window and the SSBs is determined.

It needs to be noted that, assuming that the above first search window with the highest priority is SS #1, and the second search window with a priority just lower than that of SS #1 is SS #2, after determining the mapping relationship between the MOs of SS #1 and the SSBs as well as the mapping relationship between the MOs of SS #2 and the SSBs, if the mapping relationship between the MOs of SS #3 and the SSBs needs to be determined according to the priority sequence, at this time, the above designated search spaces include SS #1 and SS #2, and SS #3 serves as a new second search space, so as to determine the mapping relationship between the MOs of SS #3 and the SSBs according to the above steps.

By parity of reasoning, until MOs of all different SSs in the scheduling window have been mapped with the SSBs.

In the above example, when one scheduling window is associate with the plurality of G-RNTIs, the network side device can accurately determine the mapping relationship between the MOs of each search space and the SSBs, so as to ensure that terminals at different geographic positions in a cell can receive the PDCCH transmitted in the search space, such that the normal operation of a terminal service is ensured, and the availability is high.

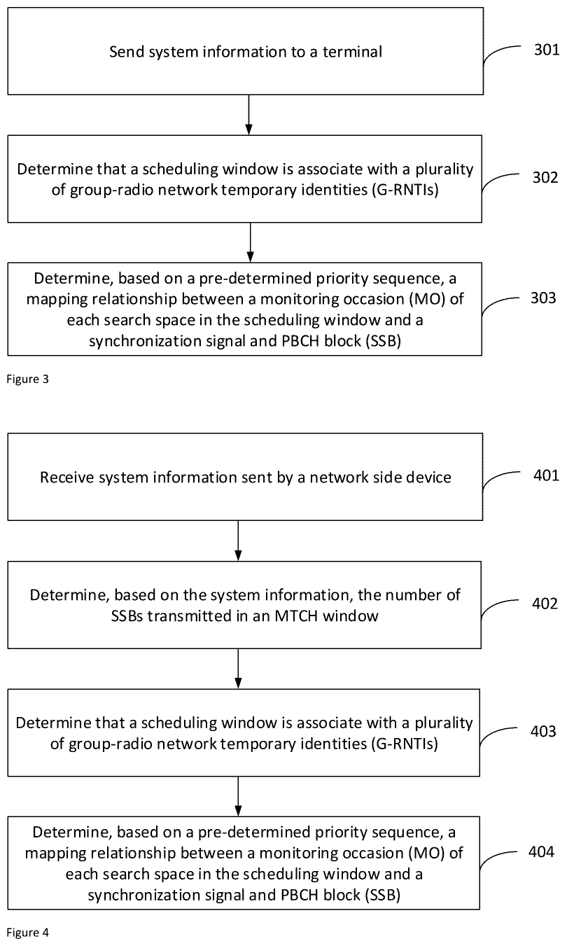

In some optional examples, as shown with reference to FIG. 3, FIG. 3 is a flowchart of a mapping relationship determining method illustrated according to an example, which may be performed by a network side device, where the network side device may be a base station, and the method may include the following steps.

In step 301, system information is sent to a terminal.

In the example of the disclosure, the system information may include the number of SSBs transmitted in a window. The number of the SSBs here may be the number of SSBs actually sent in the scheduling window as informed to the terminal by the network side device via the system information.

In a possible embodiment, the system information may be SIB1.

In another possible embodiment, the number of the SSBs may be included in an ssb-PositionsInBurst information unit of the system information SIB1.

In step 302, the scheduling window associating with a plurality of group-radio network temporary identities (G-RNTIs) is determined.

In the example of the disclosure, the scheduling window may be an MTCH scheduling window.

In a possible embodiment, PDCCHs transmitted in the different search spaces of the scheduling window are scrambled through different G-RNTIs in the plurality of G-RNTIs associate with the scheduling window.

In step 303, based on a pre-determined priority sequence, a mapping relationship between a monitoring occasion (MO) of each search space in the scheduling window and a synchronization signal and PBCH block (SSB) is determined.

In the example of the disclosure, the MO is used for monitoring a time-domain position of the PDCCH.

In another possible embodiment, the priority sequence may be a sequence of transmission period durations of the search spaces from large to small.

In another possible embodiment, the priority sequence is a sequence of transmission period durations of the search spaces from large to small and of identities of the search spaces from small to large.

In the example of the disclosure, the above step 301 may also be deployed alone, which is not limited by the disclosure.

In the above example, the network side device may configure the number of the SSBs via the system information so that the network side device and the terminal side may subsequently determine a mapping relationship between monitoring occasions (MOs) of each search space in the scheduling window and the synchronization signal and PBCH blocks (SSB) based on the number of the SSBs, which is easy to implement and has high availability.

The mapping relationship determining method provided by the disclosure is then introduced below from the terminal side.

In the example of the disclosure, there is a need to ensure that the terminal side and the network side device have a consistent understanding, i.e., to ensure that the mapping relationships between the MOs and the SSBs determined on the terminal side and the side of the network side device are consistent.

Thus, the terminal side may determine the mapping relationship in a mode consistent with the network side device.

The specific embodiment is similar to the examples corresponding to steps one to three shown above provided on the side of the network side device, which will not be repeated here.

In some optional examples, as shown with reference to FIG. 4, FIG. 4 is a flowchart of a mapping relationship determining method illustrated according to an example, which may be performed by a terminal, where the terminal may be a smartphone, an ipad, a laptop, a desktop, etc., and the method may include the following steps.

In step 401, system information sent by a network side device is received.

In the example of the disclosure, the system information may include the number of SSBs transmitted in a window.

In a possible embodiment, the system information may be SIB1.

In another possible embodiment, the number of the SSBs may be included in an ssb-PositionsInBurst information unit of the system information SIB1.

In step 402, based on the system information, the number of the SSBs transmitted in the window is determined.

In step 403, the scheduling window associating with a plurality of group-radio network temporary identities (G-RNTIs) is determined.

In step 404, based on a pre-determined priority sequence, a mapping relationship between monitoring occasions (MOs) of each search space in the scheduling window and the synchronization signal and PBCH blocks (SSBs) is determined.

The MO is used for monitoring a time-domain position of a physical downlink control channel (PDCCH).

A mode of the terminal side determining, based on the pre-determined priority sequence, the mapping relationship between the monitoring occasions (MOs) of each search space in the scheduling window and the synchronization signal and PBCH blocks (SSBs) is similar to the modes of steps one to three in the above example, which will not be repeated here.

In the example of the disclosure, the above steps 401 to 402 may be deployed alone, which is not limited by the disclosure.

In the above example, when one scheduling window is associate with the plurality of G-RNTIs, both the network side device and a terminal can accurately determine the mapping relationship between the MOs of each search space and the SSBs, so as to ensure that terminals at different geographic positions in a cell can receive the PDCCH transmitted in the search space, such that the normal operation of a terminal service is ensured, and the availability is high.

In order to facilitate the understanding of the technical solution of the present application, the above method is further exemplified as follows.

In Example 1, it is assumed that a network side device configures an MTCH scheduling window for a terminal. The MTCH scheduling window contains L slots. In the example, it is assumed that L is 8. It is assumed that the network side device configures two search spaces for the terminal to transmit a PDSCH for scheduling an MTCH, where a transmission period of SS #1 is 1 slot, a transmission period of SS #2 is 2 slots, a PDCCH transmitted in SS #1 is scrambled through G-RNTI #1, and a PDCCH transmitted in SS #2 is scrambled through G-RNTI #2.

Assuming that the number of optional SSBs actually transmitted by the terminal is 4, the network side device in the example may configure the number of SSBs by an ssb-PositionsInBurst information unit carried in SIB1.

The network side device and the terminal determine a mapping relationship between MOs of each search space in the MTCH scheduling window and the SSBs according to the following steps.

Step 11, in the MTCH scheduling window, the mapping between MOs of a search space with a maximum transmission period and the SSBs is first completed.

In the example of the disclosure, a transmission period duration of SS #2 is the largest, so a mapping relationship between MOs of SS #2 and the SSBs is first determined.

Specifically, an [x×N+K]^{th} PDCCH MO in the window is associate with the K^{th} SSB, and the MO is the MO of the search space, here specifically the MO of SS #2, where x=0, 1, . . . X−1, K=1, 2, . . . N, N is the number of SSBs actually sent by the network side device as determined by ssb-PositionsInBurst, and X is equal to the number of CEILs, i.e., X is equal to the number of MOs of the search space in the MTCH transmission window/N.

Referring to FIG. 5, it is shown that the first MO of SS #2 is associate with SSB #1, the second MO is associate with SSB #2, the third MO is associate with SSB #3, and the fourth MO is associate with SSB #4.

Step 12, in the MTCH scheduling window, a mapping relationship between MOs of the search space having a second largest transmission period and the SSBs is determined. That is, the mapping relationship between the MOs of SS #1 and the SSBs is determined.

For second MOs of the second search space (here specifically MO #1, MO #3, MO #5, and MO #7 of SS #1) that overlap with first MOs of the first search space (here specifically MO #1, MO #2, MO #3, and MO #4 of SS #2), the SSBs of mapping are determined according to the MOs of the first search space. That is, referring to FIG. 5, MO #1 of SS #1 corresponds to SSB #1, MO #3 corresponds to SSB #2, MO #5 corresponds to SSB #3, and MO #7 corresponds to SSB #4.

The other MOs of SS #1 that do not overlap with the above MOs of SS #2 are mapped one by one with the remaining SSBs in a time sequence. Specifically, a [y×M+K]^{th} PDCCH monitoring occasion in the window is associate with a P^{th} SSB, and the MO is the MO of the second SS that does not overlap with the MOs of the first SS, where y=0, 1, . . . Y−1, P=1, 2, . . . M, M is the number N of SSBs actually sent as determined by ssb-PositionsInBurst minus the number of SSBs that have been mapped, and Y is equal to CEIL (the number of MOs of the second SS in the MTCH transmission window of the search space that have not been mapped with SSBs/M).

In this example, referring to FIG. 5, MO #2 of SS #1 corresponds to SSB #3 for binding, MO #4 corresponds to SSB #4, MO #6 corresponds to SSB #1, and MO #8 corresponds to SSB #2.

On the basis of the above two steps, the mapping relationship between all MOs in the MTCH scheduling window and the SSBs is completed, and the mapping relationship between the MOs and the SSBs is finally determined.

In the above example, compared to the search space where the mapping relationship between MOs and SSBs has been previously determined, the search space with the lower priority has some MOs that overlap in time domain, and thus SSBs corresponding to the overlapping MOs as well as SSBs corresponding to non-overlapping MOs may be respectively determined based on the above mode. Ultimately, in the case of one scheduling window is associate with a plurality of G-RNTIs, a purpose is realized that both the network side device and the terminal can accurately determine the mapping relationship between MOs of each search space and the SSBs. It is ensured that terminals at different geographic positions in a cell can receive the PDCCH transmitted in the search space, such that the normal operation of a terminal service is ensured, and the availability is high.

In Example 2, it is assumed that a network side device configures an MTCH scheduling window for a terminal. The MTCH scheduling window contains L slots. In the example, it is assumed that L is 16. It is assumed that the network side device configures two search spaces for the terminal to transmit a PDSCH for scheduling an MTCH, where a transmission period of SS #1 is 2 slots, a transmission period of SS #2 is 2 slots, a PDCCH transmitted in SS #1 is scrambled through G-RNTI #1, and a PDCCH transmitted in SS #2 is scrambled through G-RNTI #2. MOs of SS #1 and SS #2 satisfy time division multiplexing in time domain, i.e., the MOs do not overlap at all in time domain.

Assuming that the number of optional SSBs actually transmitted by the terminal is 4, the network side device in the example may configure the number of SSBs by an ssb-PositionsInBurst information unit carried in SIB1.

The network side device and the terminal determine a mapping relationship between MOs of each search space in the MTCH scheduling window and the SSBs according to the following steps.

Step 21, in the MTCH scheduling window, the mapping of MOs of a search space with a smallest SS ID and the SSBs is first completed. That is, the mapping relationship between the MOs of SS #1 and the SSBs is first determined.

Specifically, an [x×N+K]^{th} PDCCH monitoring occasion of SS #1 in the window is associate with the K^{th} SSB, and the MO is an MO of the search space, where x=0, 1, . . . X−1, K=1, 2, . . . N, N is the number of SSBs actually sent as determined by ssb-PositionsInBurst, and X is equal to CEIL (the number of MOs of the search space in the MTCH transmission window/N).

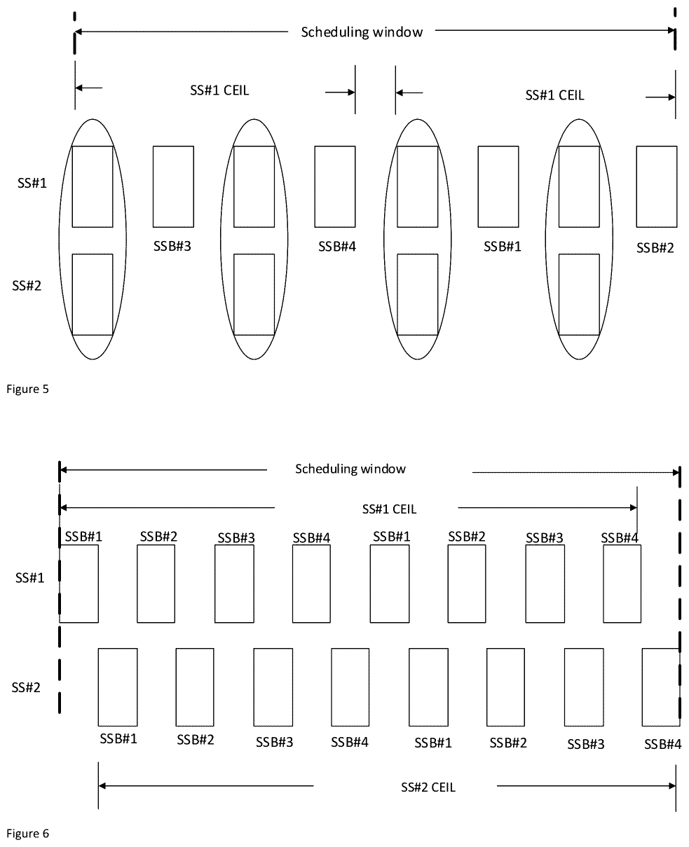

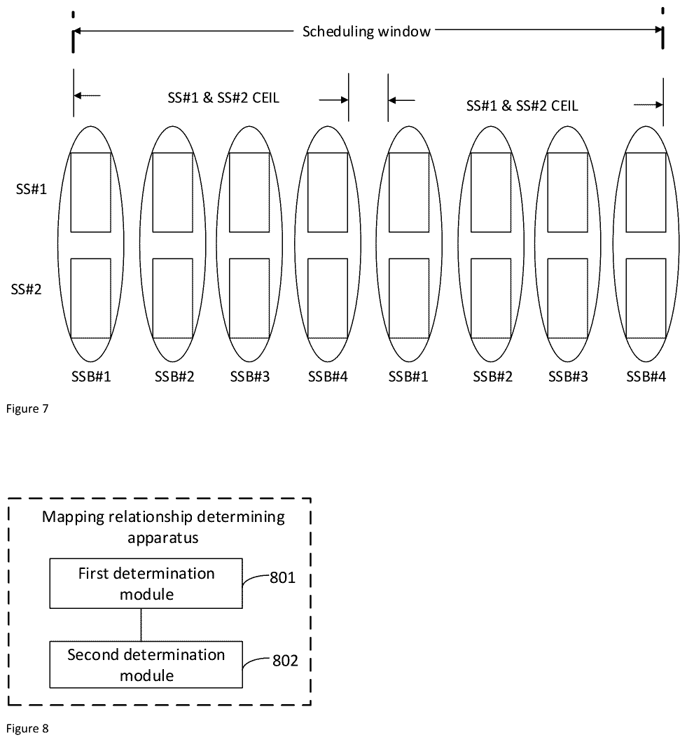

That is, referring to FIG. 6, it is shown that MO #1 of SS #1 is associate with SSB #1, MO #2 is associate with SSB #2, MO #3 is associate with SSB #3, MO #4 is associate with SSB #4, MO #5 is associate with SSB #1, MO #6 is associate with SSB #2, MO #7 is associate with SSB #3, and MO #8 is associate with SSB #4.

Step 22, in the MTCH scheduling window, the mapping of MOs of a search space with a second smaller SS ID to the SSBs is completed, i.e., a mapping relationship between the MOs of SS #2 and the SSBs is determined.

Specifically, the mapping relationship of SS #2 in the window is determined in the same mode as the mapping relationship of SS #1, the [x×N+K]^{th} PDCCH monitoring occasion is associate with the K^{th} SSB, and the MO is the MO of the search space, where x=0, 1, . . . X−1, K=1, 2, . . . N, N is the number of SSBs actually sent as determined by ssb-PositionsInBurst, and X is equal to CEIL (the number of MOs of the search space in the MTCH transmission window/N).

That is, referring to FIG. 6, it is shown that MO #1 of SS #2 is associate with SSB #1, MO #2 is associate with SSB #2, MO #3 is associate with SSB #3, MO #4 is associate with SSB #4, MO #5 is associate with SSB #1, MO #6 is associate with SSB #2, MO #7 is associate with SSB #3, and MO #8 is associate with SSB #4.

In the above example, compared to the search space where the mapping relationship between MOs and SSBs has been previously determined, MOs of the search space with the lower priority do not overlap at all in time domain, and thus after the mapping relationship between the MOs of the SS with the high priority and the SSBs is determined based on the above mode, the mapping relationship between the MOs of the SS with the lower priority and the SSBs may be determined in the same mode. Ultimately, in the case of one scheduling window is associate with a plurality of G-RNTIs, a purpose is realized that both the network side device and the terminal can accurately determine the mapping relationship between MOs of each search space and the SSBs. It is ensured that terminals at different geographic positions in a cell can receive the PDCCH transmitted in the search space, such that the normal operation of a terminal service is ensured, and the availability is high.

In Example 3, it is assumed that a network side device configures an MTCH scheduling window for a terminal. The MTCH scheduling window contains L slots. In the example, it is assumed that L is 4. It is assumed that the network side device configures two search spaces for the terminal to transmit a PDSCH for scheduling an MTCH, where a transmission period of SS #1 is 2 slots, a transmission period of SS #2 is 2 slots, a PDCCH transmitted in SS #1 is scrambled through G-RNTI #1, and a PDCCH transmitted in SS #2 is scrambled through G-RNTI #2. MOs of SS #1 and SS #2 overlap completely in time domain.

Assuming that the number of optional SSBs actually transmitted by the terminal is 4, the network side device in the example may configure the number of SSBs by an ssb-PositionsInBurst information unit carried in SIB1.

In this example, the mapping relationships between the MOs of SS #1 and SS #2 and SSBs are identical and determined according to the following method.

An [x×N+K]^{th} PDCCH monitoring occasion of in the window is associate with the K^{th} SSB, and the MO is an MO of the search space, where x=0, 1, . . . X−1, K=1, 2, . . . N, N is the number of SSBs actually sent as determined by ssb-PositionsInBurst, and X is equal to CEIL (the number of MOs of the search space in the MTCH transmission window/N).

Referring to FIG. 7, it is shown that MO #1 is associate with SSB #1, MO #2 is associate with SSB #2, MO #3 is associate with SSB #3, MO #4 is associate with SSB #4, MO #5 is associate with SSB #1, MO #6 is associate with SSB #2, MO #7 is associate with SSB #3, and MO #8 is associate with SSB #4.

In the above example, MOs of the search spaces of different priorities overlap completely in time domain, so that a mapping relationship between the MOs of the SSs of different priorities and the SSBs may be determined based on the above mode. Ultimately, in the case of one scheduling window is associate with a plurality of G-RNTIs, a purpose is realized that both the network side device and the terminal can accurately determine the mapping relationship between MOs of each search space and the SSBs. It is ensured that terminals at different geographic positions in a cell can receive the PDCCH transmitted in the search space, such that the normal operation of a terminal service is ensured, and the availability is high.

Corresponding to the foregoing examples of application function realization methods, the disclosure also provides examples of application function realization apparatuses.

Referring to FIG. 8, FIG. 8 is a block diagram of a mapping relationship determining apparatus illustrated according to an example. The mapping relationship determining apparatus includes:

a first determination module 801, configured to determine that a scheduling window is associate with a plurality of group-radio network temporary identities (G-RNTIs); and

a second determination module 802, configured to determine, based on a pre-determined priority sequence, a mapping relationship between a monitoring occasion (MO) of each search space in the scheduling window and a synchronization signal and PBCH block (SSB); where the MO is used for monitoring a time-domain position of a physical downlink control channel (PDCCH).

As for the apparatus example, as it basically corresponds to the method examples, please refer to the partial description of the method examples for related parts. The apparatus example described above is merely illustrative. Units described as separate components may or may not be physically separated, and the components displayed as units may or may not be physical units, that is, they may be located in one place, or they may be distributed onto a plurality of network units. Some or all of the modules may be selected according to actual needs to implement the objective of the solution of the disclosure. Those of ordinary skill in the art may understand and implement it without creative work.

Correspondingly, the disclosure further provides a computer readable storage medium. The storage medium stores a computer program, and the computer program is used for executing the mapping relationship determining method according to any one of the above.

Correspondingly, the disclosure further provides a mapping relationship determining apparatus, including:
a processor; and
a memory configured to store processor executable instructions;
where the processor is configured to execute the mapping relationship determining method according to any of the above.

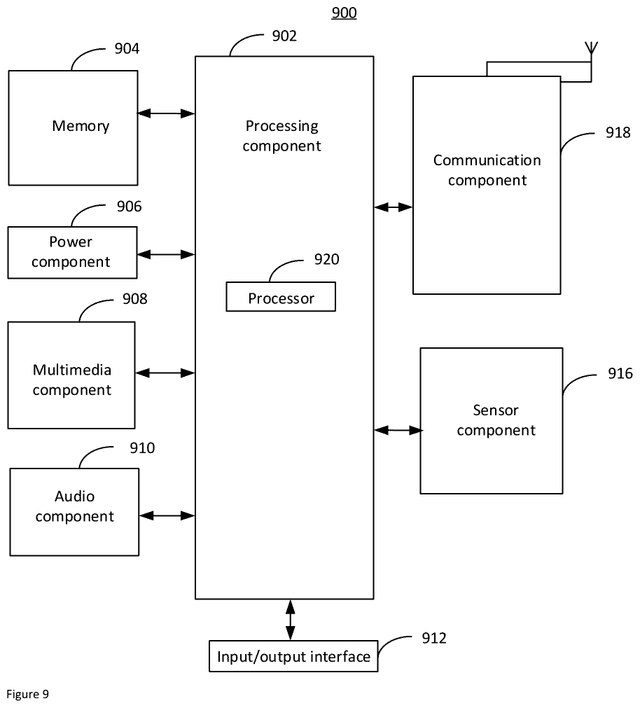

FIG. 9 is a block diagram of an electronic device 900 illustrated according to an example. For example, the electronic device 900 may be a terminal such as a cell phone, a tablet computer, an e-book reader, a multimedia playback device, a wearable device, a vehicle terminal, an ipad, and a smart TV.

Referring to FIG. 9, the electronic device 900 may include one or more of the following components: a processing component 902, a memory 904, a power component 906, a multimedia component 908, an audio component 910, an input/output (I/O) interface 912, a sensor component 916, and a communication component 918.

The processing component 902 typically controls an overall operation of the electronic device 900, such as operations associated with display, a telephone call, data communication, a camera operation, and a recording operation. The processing component 902 may include one or more processors 920 to execute instructions to complete all or part of the steps of the above mapping relationship determining method. In addition, the processing component 902 may include one or more modules to facilitate interaction between the processing component 902 and other components. For example, the processing component 902 may include a multimedia module to facilitate interaction between the multimedia component 908 and the processing component 902. For another example, the processing component 902 may read an executable instruction from the memory to implement the steps of one mapping relationship determining method provided in the above examples.

The memory 904 is configured to store various types of data to support operations at the electronic device 900. Examples of these data include instructions for any application or method operating on the electronic device 900, contact data, phonebook data, messages, pictures, videos, etc. The memory 904 may be implemented by any type of volatile or nonvolatile storage device or their combination, such as a static random access memory (SRAM), an electrically erasable programmable read only memory (EEPROM), an erasable programmable read only memory (EPROM), a programmable read only memory (PROM), a read only memory (ROM), a magnetic memory, a flash memory, a magnetic disk or an optical disk.

The power component 906 provides power for various components of the electronic device 900. The power component 906 may include a power management system, one or more power sources and other components associated with generating, managing and distributing power for the electronic device 900.

The multimedia component 908 includes a display screen providing an output interface between the electronic device 900 and a user. In some examples, the multimedia component 908 includes a front camera and/or a rear camera. When the electronic device 900 is in an operation mode, such as a shooting mode or a video mode, the front camera and/or the rear camera can receive external multimedia data. Each front camera and rear camera may be a fixed optical lens system or have a focal length and optical zoom capability.

The audio component 910 is configured to output and/or input audio signals. For example, the audio component 910 includes a microphone (MIC) configured to receive an external audio signal when the electronic device 900 is in the operation mode, such as a call mode, a recording mode, and a speech recognition mode. The received audio signal may be further stored in the memory 904 or transmitted via the communication component 918. In some examples, the audio component 910 also includes a speaker for outputting an audio signal.

The I/O interface 912 provides an interface between the processing component 902 and a peripheral interface module which may be a keyboard, a click wheel, a button, etc. These buttons may include but are not limited to: a home button, a volume button, a start button and a lock button.

The sensor component 916 includes one or more sensors for providing state evaluation of various aspects of the electronic device 900. For example, the sensor component 916 may detect an on/off state of the electronic device 900, and relative positioning of components, such as the components being a display and a keypad of the electronic device 900, the sensor component 916 may further detect a change in the position of the electronic device 900 or a component of the electronic device 900, the presence or absence of contact of the user with the electronic device 900, the orientation or acceleration/deceleration of the electronic device 900 and temperature changes of the electronic device 900. The sensor component 916 may include a proximity sensor configured to detect the presence of nearby objects without any physical contact. The sensor component 916 may further include an optical sensor, such as a CMOS or CCD image sensor, for use in imaging applications. In some examples, the sensor component 916 may further include an acceleration sensor, a gyroscope sensor, a magnetic sensor, a pressure sensor, or a temperature sensor.

The communication component 918 is configured to facilitate wired or wireless communication between the electronic device 900 and other devices. The electronic device 900 may access a wireless network based on a communication standard, such as Wi-Fi, 2G, 3G, 4G, 5G or 6G, or a combination of them. In an example, the communication component 918 receives a broadcast signal or broadcast-related information from an external broadcast management system via a broadcast channel. In an example, the communication component 918 further includes a near field communication (NFC) module to facilitate short-range communication. For example, the NFC module may be implemented based on radio frequency identification (RFID) technology, infrared data association (IrDA) technology, ultra wideband (UWB) technology, Bluetooth (BT) technology and other technologies.

In an example, the electronic device 900 may be implemented by one or more application-specific integrated circuits (ASICs), digital signal processors (DSPs), digital signal processing devices (DSPDs), programmable logic devices (PLDs), field-programmable gate arrays (FPGAs), controllers, microcontrollers, microprocessors, or other electronic elements for executing the above mapping relationship determining method.

In an example, a non-transitory machine readable storage medium is further provided and includes instructions, such as a memory 904 including instructions, which can be executed by the processor 920 of the electronic device 900 to complete the above mapping relationship determining method. For example, the non-transitory computer-readable storage medium may be an ROM, a random access memory (RAM), a CD-ROM, a magnetic tape, a floppy disk, an optical data storage device, etc.

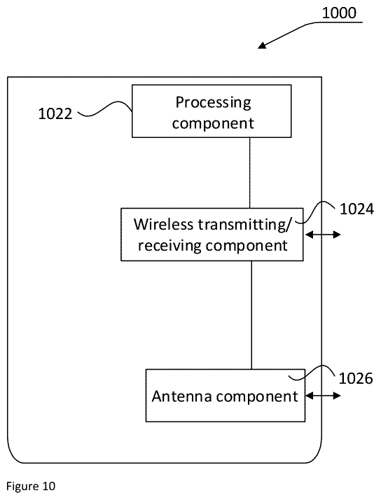

As shown in FIG. 10, FIG. 10 is a schematic structural diagram of a mapping relationship determining apparatus 1000 illustrated according to an example. The apparatus 1000 may be provided as a network side device. Referring to FIG. 10, the apparatus 1000 includes a processing component 1022, a wireless transmitting/receiving component 1024, an antenna component 1026, and a signal processing part specific to the wireless interface, and the processing component 1022 may further include at least one processor.

One processor in the processing component 1022 may be configured to execute the mapping relationship determining method according to any one of the above on the side of the network side device.

Other implementation solutions of the disclosure will be apparent to those skilled in the art from consideration of the specification and practice of the disclosure here. The disclosure is intended to cover any variations, uses, or adaptations of the disclosure that follow the general principles of the disclosure and include common knowledge or customary technical means in the technical field not disclosed in the disclosure. The description and examples are considered as examples merely, and the true scope and spirit of the disclosure is indicated by the following claims.

It is to be understood that the disclosure is not limited to the exact construction that has been described above and illustrated in the accompanying drawings, and that various modifications and changes may be made without departing from its scope. The scope of the disclosure is merely limited by the appended claims.

1. A mapping relationship determining method, comprising:
determining that a scheduling window is associate with a plurality of group-radio network temporary identities (G-RNTIs); and
determining, based on a pre-determined priority sequence, a mapping relationship between a monitoring occasion (MO) of each search space in the scheduling window and a synchronization signal and PBCH block (SSB); wherein the MO is used for monitoring a time-domain position of a physical downlink control channel (PDCCH).

2. The mapping relationship determining method according to claim 1, wherein determining, based on the pre-determined priority sequence, the mapping relationship between the monitoring occasion (MO) of each search space in the scheduling window and the synchronization signal and PBCH block (SSB) comprises:
determining, based on a first mapping mode, a mapping relationship between an MO of a first search space and the SSB; wherein the first search space is a search space with a highest priority;
determining, based on an overlapping relationship between an MO of a second search space and an MO of a designated search space in time domain, a second mapping mode; wherein the designated search space is a search space where a mapping relationship between the MO and the SSB has been determined, and a priority of the second search space is lower than a priority of the designated search space; and
determining, based on the second mapping mode, a mapping relationship between the MO of the second search space and the SSB until the mapping relationship between the MO of each search space in the scheduling window and the SSB is determined.

3. The mapping relationship determining method according to claim 2, wherein the first mapping mode comprises:
MOs of the first search space in a time sequence from early to late being in one-to-one correspondence with SSBs with identities from small to large in each mapping loop of the scheduling window.

4. The mapping relationship determining method according to claim 3, further comprising:
determining, based on a number of the MOs of the first search space in the scheduling window and a number of the SSBs transmitted in the scheduling window, a number of the mapping loops.

5. The mapping relationship determining method according to claim 2, wherein the second mapping mode is the same as a mapping mode of the designated search space in a case where the overlapping relationship indicates that the MO of the second search space overlaps completely or not at all with the MO of the designated search space in time domain.

6. The mapping relationship determining method according to claim 2, wherein in a case where the overlapping relationship indicates that part of the MOs of the second search space overlaps with part of the MOs of the designated search space in time domain, the second mapping mode comprises:
each MO on the second search space which has the overlapping relationship with the designated search space corresponding to a designated SSB; wherein the designated SSB is an SSB corresponding to the MO on the designated search space which has the overlapping relationship with the second search space; and
the other MOs of the second search space in a time sequence from early to late being in one-to-one correspondence with the remaining SSBs.

7. The mapping relationship determining method according to claim 1, wherein the pre-determined priority sequence is at least one of a sequence of transmission period durations of the search spaces from large to small; or
a sequence of identities of the search spaces from small to large.

8. The mapping relationship determining method according to claim 1, performed by a network side device; and
further comprising:
sending system information to a terminal; wherein the system information comprises a number of the SSBs transmitted in the scheduling window.

9. The mapping relationship determining method according to claim 1, performed by a terminal device; and
further comprising:
receiving system information sent by a network side device; and
determining, based on the system information, a number of the SSBs transmitted in the scheduling window.

10. The mapping relationship determining method according to claim 1, wherein PDCCHs transmitted in different search spaces are scrambled through different G-RNTIs in the plurality of G-RNTIs.

11. (canceled)

12. A non-transitory computer readable storage medium, storing a computer program, wherein the computer program is used for executing the mapping relationship determining method according to one of above claim 1.

13. A mapping relationship determining apparatus, comprising:
one or more processors; and
a memory configured to store processor executable instructions;
wherein the one or more processors are collectively configured to:
determine that a scheduling window is associate with a plurality of group-radio network temporary identities (G-RNTIs); and
determine, based on a pre-determined priority sequence, a mapping relationship between a monitoring occasion (MO) of each search space in the scheduling window and a synchronization signal and PBCH block (SSB); wherein the MO is used for monitoring a time-domain position of a physical downlink control channel (PDCCH).

14. The mapping relationship determining apparatus according to claim 13, wherein the one or more processors are further collectively configured to:
determine, based on a first mapping mode, a mapping relationship between an MO of a first search space and the SSB; wherein the first search space is a search space with a highest priority;
determine, based on an overlapping relationship between an MO of a second search space and an MO of a designated search space in time domain, a second mapping mode; wherein the designated search space is a search space where a mapping relationship between the MO and the SSB has been determined, and a priority of the second search space is lower than a priority of the designated search space; and
determine, based on the second mapping mode, a mapping relationship between the MO of the second search space and the SSB until the mapping relationship between the MO of each search space in the scheduling window and the SSB is determined.

15. The mapping relationship determining apparatus according to claim 14, wherein the first mapping mode comprises:
MOs of the first search space in a time sequence from early to late being in one-to-one correspondence with SSBs with identities from small to large in each mapping loop of the scheduling window.

16. The mapping relationship determining apparatus according to claim 15, wherein the one or more processors are further collectively configured to:
determine, based on a number of the MOs of the first search space in the scheduling window and a number of the SSBs transmitted in the scheduling window, a number of the mapping loops.

17. The mapping relationship determining apparatus according to claim 14, wherein the second mapping mode is the same as a mapping mode of the designated search space in a case where the overlapping relationship indicates that the MO of the second search space overlaps completely or not at all with the MO of the designated search space in time domain.

18. The mapping relationship determining apparatus according to claim 14, wherein in a case where the overlapping relationship indicates that part of the MOs of the second search space overlaps with part of the MOs of the designated search space in time domain, the second mapping mode comprises:
each MO on the second search space which has the overlapping relationship with the designated search space corresponding to a designated SSB; wherein the designated SSB is an SSB corresponding to the MO on the designated search space which has the overlapping relationship with the second search space; and
the other MOs of the second search space in a time sequence from early to late being in one-to-one correspondence with the remaining SSBs.

19. The mapping relationship determining apparatus according to claim 13, wherein the pre-determined priority sequence is at least one of a sequence of transmission period durations of the search spaces from large to small; or
a sequence of identities of the search spaces from small to large.

20. The mapping relationship determining apparatus according to claim 13, wherein the one or more processors are further collectively configured to:
send system information to a terminal; wherein the system information comprises a number of the SSBs transmitted in the scheduling window.

21. The mapping relationship determining apparatus according to claim 13, wherein the one or more processors are further collectively configured to:
receive system information sent by a network side device; and
determine, based on the system information, a number of the SSBs transmitted in the scheduling window.
